(19) United States
(12) Patent Application Publication
(10) Pub. No.: US 2026/0223104 A1
(43) Pub. Date: Jul. 30, 2026

(54) WIRELESS COMMUNICATION METHOD AND RELATED DEVICES

(71) Applicant: SHENZHEN TCL NEW TECHNOLOGY CO., LTD., Shenzhen, Guangdong (CN)

(72) Inventor: Yiwei DENG, Shenzhen, Guangdong (CN)

(73) Assignee: SHENZHEN TCL NEW TECHNOLOGY CO., LTD., Shenzhen, Guangdong (CN)

(21) Appl. No.: 19/144,492

(22) PCT Filed: Dec. 30, 2022
(86) PCT No.: PCT/CN2022/144207

§ 371 Date: Jun. 29, 2025

(51) Int. Cl. H04W 72/1263; H04W 72/23

(52) U.S. Cl. CPC H04W 72/1263; H04W 72/23

(57) ABSTRACT

A wireless communication method and related devices such as a user equipment (UE) and a base station (BS) (e.g., a gNB) are provided. The wireless method, performed by a UE, including being configured with multiple resources or transmission occasions (TOs) within a configured grant (CG) configuration. The CG configuration can be a single CG configuration or one of multiple CG configurations. With this method, a CG configuration with multiple transmission occasions is realized.

### TECHNICAL FIELD

The present application relates to wireless communication technologies, and more particularly, to a wireless communication method, and related devices such as a user equipment (UE) and a base station (BS) (e.g., a gNB).

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN) The RAN includes a set of base stations (BSs) which provide wireless links to the UEs located in cells covered by the base stations, and an interface to a core network (CN) which provides overall network control. The RAN and CN each conducts respective functions in relation to the overall network.

The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by base station knowns as an eNodeB or eNB (evolved NodeB) LTE is evolving further towards the so-called 5G or NR (new radio) systems where one or more cells are supported by base stations known as a next generation Node B called gNodeB (gNB).

The 5G New Radio (NR) standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

EXtended Reality (XR) and Cloud Gaming are some of the most important 5G media applications under consideration in the industry. XR is an umbrella term for different types of realities and refers to all real-and-virtual combined environments and human-machine interactions generated by computer technology and wearables. It includes representative forms such as Augmented Reality (AR), Mixed Reality (MR) and Virtual Reality (VR) and the areas interpolated among them. A new Study Item Description (SID) on XR evaluation has been approved in 3GPP. The characteristics of XR traffic and challenges are summarized below:

### High Data Rate With Limited Latency

For 3D VR videos with high resolution based on different frame rates, color codecs, bit-depths, compression rates and etc., the transmission date rate could be up to 60 Mbps and above with limited latency, around 10~30 ms.

### Non-Integer Period With Jitter

It has been agreed that 60 frames per second (fps) is baseline for both Downlink (DL) and Uplink (UL) video stream and 30 fps, 90 fps as well as 120 fps can be also optionally evaluated. Based on the formula of arrival time of packet, the corresponding periodicities are 33.33 ms, 16.67 ms, 11.11 ms and 8.33 ms, respectively. In addition, there has jitter characteristic for XR traffic arrival. According to the previous 3GPP RAN1 agreements, the jitter can be modeled as truncated Gaussian distribution with varying range of [−4,4] ms (baseline) or [−5,5] ms (optional).

### Varying Frame Size

In the field of video compression, three major frame types are defined through three different video algorithms with the following characteristics:
I-frames are the least compressible ones which can decode independently.
P-frames can use previous frames to decompress and are more compressible than I-frames.
B-frames can use both previous and forward frames to get the highest amount of data compression.

In current 3GPP RAN1 meetings, increasing the number of Configured Grant (CG) Physical Uplink Shared Channel (PUSCH) transmission occasions (TOs) in a duration has been discussed and several agreements have been reached on RAN1 #111 meeting. The agreements are shown below.
Agreement 1: Support dynamic indication of the unused CG PUSCH occasion(s) based on Uplink Control Information (UCI) (e.g., CG-UCI or a new UCI) by the UE.
Agreement 2: Support multiple CG PUSCH transmission occasions in a period of a single CG PUSCH configuration.

As the XR video traffic is periodically generated and has low latency requirement, it is beneficial to adopt CG resources for uplink (UL) XR video transmission without scheduling request (SR) and buffer status report (BSR) procedures from UE. For XR video, the large frame size may require more than one PUSCHs to be transmitted in each video frame period. So more than one PUSCH transmission occasions within a CG configuration is beneficial for XR to handle the issue of varying frame size.

However, there are still some issues needed to be addressed for configuring multiple PUSCH transmission occasions in a CG configuration.

### Other Related Arts

In current 3GPP specification, an IE of ConfiguredGrantConfig is used to configure uplink transmission without dynamic grant according to two possible schemes. The actual uplink grant may either be configured via RRC (type1) or provided via the PDCCH (addressed to CS-RNTI) (type2). Multiple Configured Grant configurations may be configured in one BWP of a serving cell and the maximum number of CG configurations are 12.

For type 2, a UE validates, for scheduling activation or scheduling release, a DL SPS assignment PDCCH or a configured UL grant Type 2 PDCCH if
the CRC of a corresponding DCI format is scrambled with a CS-RNTI provided by es-RNTI or a G-CS-RNTI provided by g-cs-RNTI, and
the new data indicator field in the DCI format for the enabled transport block is set to ‘0’, and
the DFI flag field, if present, in the DCI format is set to ‘0’, and
the time domain resource assignment field in the DCI format indicates a row with single SLIV, and
if validation is for scheduling activation and if the PDSCH-to-HARQ feedback timing indicator field in the DCI format is present, the PDSCH-to-HARQ_feedback timing indicator field does not provide an inapplicable value from dl-DataToUL-ACK-r16

If a UE is provided a single configuration for UL grant Type 2 PUSCH or for SPS PDSCH, validation of the DCI format is achieved if all fields for the DCI format are set correspondingly.

If a UE is provided more than one configuration for UL grant Type 2 PUSCH or for SPS PDSCH, a value of the HARQ process number field in a DCI format indicates an activation for a corresponding UL grant Type 2 PUSCH or for a SPS PDSCH configuration with a same value as provided by ConfiguredGrantConfigIndex or by sps-ConfigIndex, respectively. Validation of the DCI format is achieved if the RV field for the DCI format is set correspondingly.

If a UE is provided more than one configuration for UL grant Type 2 PUSCH or for SPS PDSCH
if the UE is provided ConfiguredGrantConfigType2DeactivationStateList or sps-ConfigDeactivationStateList, a value of the HARQ process number field in a DCI format indicates a corresponding entry for scheduling release of one or more UL grant Type 2 PUSCH or SPS PDSCH configurations
if the UB is not provided ConfiguredGrantConfigType2DeactivationStateList or sps-ConfigDeactivationStateList, a value of the HARQ process number field in a DCI format indicates a release for a corresponding UL grant Type 2 PUSCH or for a SPS PDSCH configuration with a same value as provided by ConfiguredGrantConfigIndex or by sps-ConfigIndex, respectively

Validation of the DCI format is achieved if all fields for the DCI format are set correspondingly.

If validation is achieved, the UE considers the information in the DCI format as a valid activation or valid release of DL SPS or configured UL grant Type 2. If validation is not achieved, the UE discards all the information in the DCI format.

With current mechanism, a single CG configuration and multiple CG configurations can be configured. A DCI or multiple DCIs can be used to activate or deactivate one or more CG configurations. In addition, repetition can be configured in a CG configuration, and two types of PUSCH transmission are defined, in which one is type A PUSCH repetition and the other is type B PUSCH repetition. Type A PUSCH repetition is based on slot and with at most one repetition within a slot, and the time and frequency of each CG configuration within a slot is the same. For type B PUSCH repetition, the repetition pattern is back-to-back in time domain, and more than one repetitions can be configured within a slot.

### SUMMARY

The objective of the present application is to provide a wireless communication method and related devices, for realizing multiple transmission occasions (TOs) within a CG configuration.

In a first aspect, an embodiment of the present application provides a wireless communication method, performed by a user equipment (UE), the method including: being configured with multiple resources or transmission occasions (TOs) within a configured grant (CG) configuration.

In a second aspect, an embodiment of the present application provides a wireless communication method, performed by a base station (BS), the method including: configuring a user equipment (UE) with multiple resources or transmission occasions (TOs) within a configured grant (CG) configuration.

In a third aspect, an embodiment of the present application provides a user equipment (UE), including a processor, a transceiver and a memory, wherein the processor, the transceiver and the memory communicate with each other through an internal connection path, the memory is used for storing instructions, and the processor is used for, when executing the instructions stored in the memory, executing the method of the first aspect.

In a fourth aspect, an embodiment of the present application provides a base station (BS), including a processor, a transceiver and a memory, wherein the processor, the transceiver and the memory communicate with each other through an internal connection path, the memory is used for storing instructions, and the processor is used for, when executing the instructions stored in the memory, executing the method of the second aspect.

In a fifth aspect, an embodiment of the present application provides a computer readable storage medium provided for storing a computer program, which enables a computer to execute the method of any of the first and the second aspects.

In a sixth aspect, an embodiment of the present application provides a computer program product, which includes computer program instructions enabling a computer to execute the method of any of the first and the second aspects.

In a seventh aspect, an embodiment of the present application provides a computer program, when running on a computer, enabling the computer to execute the method of any of the first and the second aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a block diagram of a user equipment and a base station of wireless communication in a communication controlling system according to an embodiment of the present application.

FIG. 2 is a schematic diagram illustrating radio protocol architecture within gNB and UE.

FIG. 3 is a schematic diagram illustrating a gNB further including a centralized unit (CU) and a plurality of distributed unit (DUs).

FIG. 4 is a flowchart of a wireless communication method according to an embodiment of the present application.

FIG. 5 is a schematic diagram illustrating Multiple TOs within a CG configuration that share the same parameters according to an embodiment of the present application.

FIG. 6 is a schematic diagram illustrating Two-stage index used to indicate multiple TOs within a CG configuration according to an embodiment of the present application.

FIG. 7 is a schematic diagram illustrating Multiple TBs/PUSCHs with repetition first according to an embodiment of the present application.

FIG. 8 is a schematic diagram illustrating Multiple TBs/PUSCHs without repetition first according to an embodiment of the present application.

FIG. 9 is a schematic diagram illustrating TB mapping rule for the collision case according to an embodiment of the present application.

### DETAILED DESCRIPTION OF EMBODIMENTS

Embodiments of the application are described in detail with the technical matters, structural features, achieved objects, and effects with reference to the accompanying drawings as follows. Specifically, the terminologies in the embodiments of the present application are merely for describing the purpose of the certain embodiment, but not to limit the application.

In this document, the term “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

As the XR video traffic is periodically generated and has low latency requirement, it is beneficial to adopt configured grant (CG) for the uplink (UL) XR video transmission without scheduling request (SR) and buffer status report (BSR) procedures. For XR video, the large frame size may require more than one PUSCHs to be transmitted in each video frame period. So more than one PUSCH transmission occasions within a CG configuration is beneficial for XR to handle the issue of varying frame size. However, how to configure multiple transmission occasions (TOs) within a CG configuration and how to distinguish the transmission occasions by gNB and UE need to be studied. In addition, when the size of an actually arrived packet is smaller than an expected value due to varying frame size of XR, a portion of configured resources will be wasted. So how to indicate unused resources within a CG configuration should also be considered.

For XR services, a large buffer will be generated, and this results in having to indicate from UE to gNB a high index in the BSR procedure based on the existing BSR table. The higher the BSR index, the larger the buffer inaccuracy. This is because the BSR index is used to indicate a range of values between X and Y and the difference between X and Y is large. Enhancement methods for this issue are needed. In a way, a new field may be introduced in MAC CE for the BSR. The new field is used to indicate a more detailed range of values. For instance, 1 bit is introduced for enhancing the BSR indication. It can be used to indicate two states in total, denoted as {0,1}. It is assumed that the range of buffer states for Index 12 is from 277 to 384 bytes. The new field with value 0 may indicate an upper half of the range, and the new field with value 1 may indicate a lower half of the range. In another way, a new BSR table for XR may be provided, in which the new BSR table may have a more accurate value for XR. In still another way, when a Protocol Data Unit (PDU) set is discarded by UE, the UE needs to update the BSR value in order to achieve accurate reporting of XR BSR. However, choosing another index from a BSR table will cause more signaling overhead. How to reduce the overhead of BSR update should be studied.

In short, this application proposes approaches to determine resources/transmission occasions and patterns (with or without repetition) within a CG configuration and to indicate unused resources/transmission occasions. This application additionally proposes to provide a change rate of BSR for XR that may be reported to gNB by UE.

To enable multiple resources/transmission occasions (TOs) within a CG configuration:
The parameters of all resources/transmission occasions within a CO configuration may be shared. The parameters of the CG configuration can be used to be applied to multiple transmission occasions. A new parameter or a new column in TDRA can be introduced to determine the number of transmission occasions within the CG configuration.
The parameters of all resources/transmission occasions within a CG configuration may be shared or not shared. For example, some of the parameters of all resources/transmission occasions with the CG configuration are shared. The number of repetitions indicated by Radio Resource Control (RRC) or Downlink Control Information (DCI) for example can be used to indicate the number of TOs within the CG configuration.
The parameters of a resource/transmission occasion within a CG configuration are configured with an independent set of parameters. For example, one or more parameters are different for each one of the multiple transmission occasions within the CG configuration.

In addition, in order to reduce the signaling overhead, a potential approach is proposed to update the BSR size of XR for example, in which a change rate of BSR for XR is reported to gNB by UE.

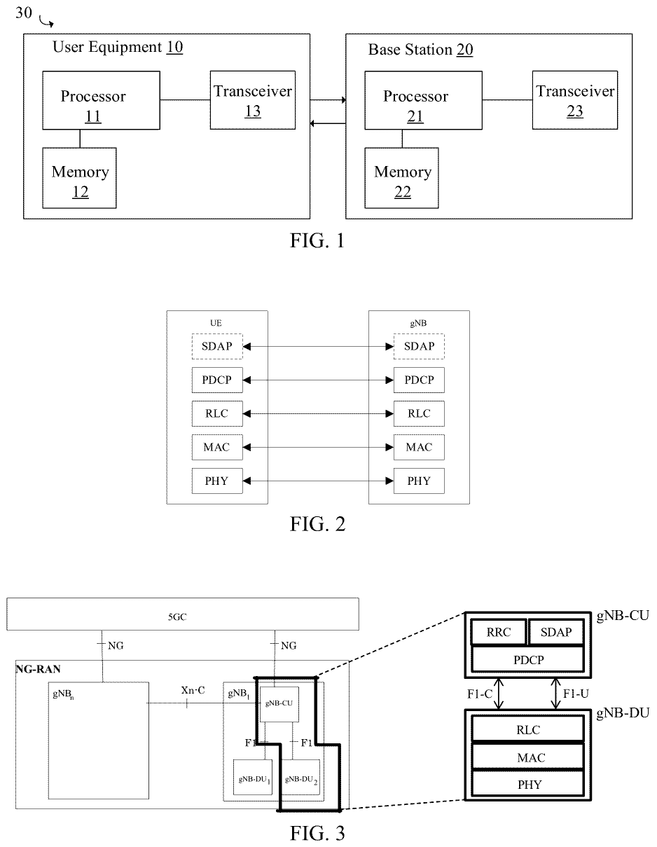

FIG. 1 illustrates that, in some embodiments, one or more user equipments (UEs) 10 and a base station (e.g., gNB or eNB) 20 for wireless communication in a communication network system 30 according to an embodiment of the present application are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal. The base station 20 and a next generation core network (5GCN) may also communicate with each other either wirelessly or in a wired way. When the communication network system 30 complies with the New Radio (NR) standard of the 3rd Generation Partnership Project (3GPP), the next generation core network is a backend serving network system and may include an Access and Mobility Management Function (AMF), User Plane Function (UPF), and a Session Management Function (SMF). In one aspect, the user equipment 10 can include almost any consumer electronic device or appliance that can connect to a radio access network and a core network for the releases of 3GPP and further, such as, but not limited to NR networks.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art. The user plane radio protocol architecture within the gNB and UE is shown in FIG. 2, which includes optional Service Data Adaptation Protocol (SDAP), Packet Data Convergence Protocol (PDCP), Radio Link Control (RLC), Medium Access Control (MAC). In RAN functional split, a gNB further includes a centralized unit (CU) and a plurality of distributed unit (DUs) as shown in FIG. 3. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer and the RLC layer.

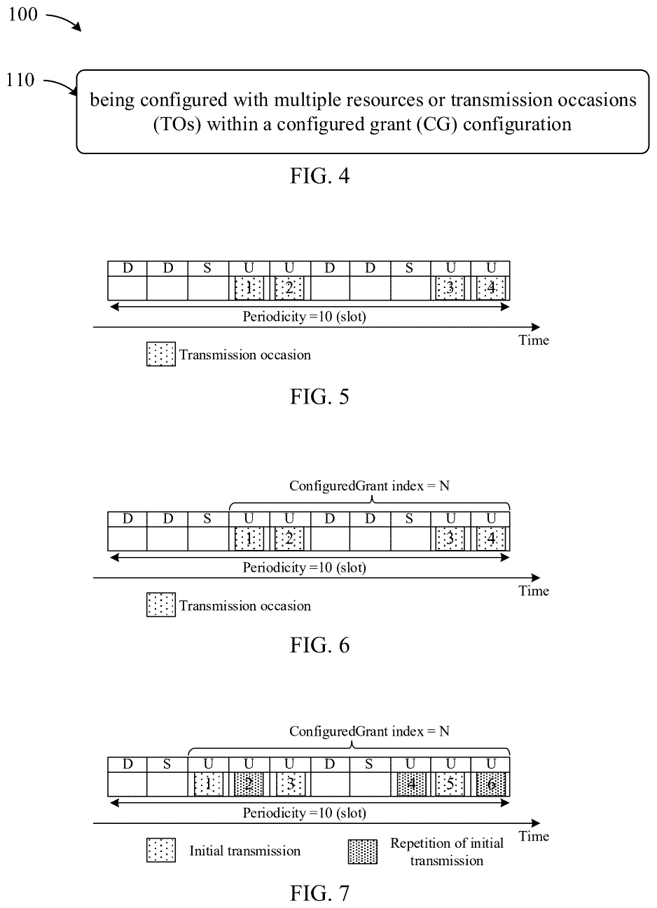

FIG. 4 illustrates a wireless communication method according to an embodiment of the present application. Referring to FIG. 4 in conjunction with FIG. 1, the method 100 includes the followings. In Step 110, the UE is configured by the base station (BS) (the BS configures the UE) with multiple resources or transmission occasions (TOs) within a configured grant (CG) configuration. That is, there are multiple resources or TOs configured in a CG configuration for Physical Uplink Shared Channel (PUSCH) transmission. The CG configuration can be a single CG configuration or one of multiple CG configurations. For the single CG configuration, one CG configuration is configured at one time. For the multiple CG configurations, more than one CG configurations are configured at one time. With this method, a CG configuration with multiple transmission occasions is realized.

In an embodiment, the number of resources or TOs within the CG configuration may be indicated by a parameter or a set of parameters, which may be received by the UE by Radio Resource Control (RRC), or by Medium Access Control (MAC) Control Element (CE), or by Downlink control information (DCI). Alternatively, when repetition transmission is configured in the CG configuration, the number of resources or TOs within the CG configuration may be based on the number of repetitions or indicated by the number of repetitions. The UE may receive from the BS a signaling used to enable a function of indicating the number of resources or TOs within the CG configuration by the number of repetitions. In some scenarios, the number of resources or TOs within the CG configuration may be based on available transmission occasions or resources. That is, only the available transmission occasions are counted in defining the number of resources or TOs within the CG configuration.

In an embodiment, parameters of the CG configuration are applied to each of the multiple resources or TOs within the CG configuration. Each resource or TO within the CG configuration may use the same parameters which are configured in the CG configuration. Furthermore, multiple sets of parameters of resource or TO within the CO configuration may be configured, and a signaling is used to indicate one set among the multiple sets of parameters of resource or TO. In another embodiment, each resource or TO within a CG configuration is configured with an individual set of parameters. That is, some parameters may be different in values for each resource or TO within the CG configuration. For example, at least one of the following parameters is different for each one of the multiple resources or TOs within the CG configuration: Frequency Domain Resource Assignment (FDRA); Time Domain Resource Allocation (TDRA); PUSCH mapping type; Hybrid Automatic Repeat Request identification (HARQ-ID); Redundancy Version (RV); or Modulation and coding scheme (MCS). In some cases, the number of resources or TOs within the CO configuration may be determined based on at least one of the following parameters: TDRA, FDRA, MCS or HARQ-ID. That is, at least one of the aforesaid parameters may be used to determine or count the number of TOs within the CG configuration.

In an embodiment, an index may be used to indicate each of the multiple resources or TOs within the CG configuration. In a more concrete example, two-stage index may be used to identify the multiple TOs within the CG configuration, in which one stage of the two-stage index is a CG configuration index, and the other stage of the two-stage index is a TO index.

In an embodiment, when transport blocks (TBs)/Physical Uplink Shared Channels (PUSCHs) transmitted on the multiple TOs are configured with repetition, a corresponding transmission pattern is formed by multiple TBs/PUSCHs with repetition first, which means a first TB/PUSCH and one or more corresponding repetitions to the first TB are transmitted before a second TB/PUSCH. In another embodiment, when TBs/PUSCHs transmitted on the multiple TOs are configured with repetition, a corresponding transmission pattern is formed by multiple TBs/PUSCHs without repetition first, which means all of TBs/PUSCHs within the CG configuration are transmitted first and then corresponding repetitions.

In an embodiment, a reference HARQ-ID of the multiple TOs within the CG configuration may be based on a first transmission occasion configured within the CG configuration or a first actual transmission occasion which is a TO with a PUSCH transmission. The reference HARQ-ID is used to determine HARQ-ID of all the TOs within the CO configuration. The HARQ-ID of remaining TOs within the CG configuration is based on the reference HARQ-ID. Moreover, the multiple TOs within the CG configuration may be grouped into a plurality of sets, and HARQ-ID of TOs within each set is the same.

In an embodiment, a PUSCH/TB may be mapped to a set of TOs among the multiple TOs within the CG configuration, and when one or more TOs within the set are collided with other transmissions, the PUSCH/TB is allocated to one of remaining TOs within the set without being allocated across the set of TOs. In another embodiment, a PUSCH/TB may be mapped to a set of TOs among the multiple TOs within the CG configuration, and when one or more TOs within the set are collided with other transmissions, the PUSCH/TB is allocated to one of remaining TOs within the set or one of next several TOs within an adjacent TO set.

In an embodiment, the UE may receive from the BS a signaling used to indicate unused resources or transmission occasions within the CG configuration. In an embodiments, a set of TOs within a CG configuration can be indicated as un-used TOs by an index or bitmap. The signaling may be carried by MAC CE, or Uplink Control Information (UCI), or CG-UCI, or piggyback UCI. In a first example, an index of TO is indicated by the signaling, and corresponding TOs from the index to the end of TOs within the CG configuration are indicated as unused TOs. In a second example, within the CG configuration, the TOs adjacent to the signaling are indicated as unused TOs. In a third example, within the CG configuration, the TOs adjacent to the signaling and larger than a threshold value are indicated as unused TOs.

In an embodiment, the UE may report to the BS a range of change of Buffer State Report (BSR) with respect to previous report. The rate of change may be pre-defined or configured in a table, in which each index in the table is used to indicate a rate value for BSR update.

Further details on how to determine resources/transmission occasions and patterns (with or without repetition) within a CG configuration and to indicate unused resources/transmission occasions are described as follows.

This application proposes approaches to determine resources/transmission occasions and patterns (with or without repetition) within a CG configuration and to indicate unused resources/transmission occasions. For the aspect of determining the resources/transmission occasions and patterns within a CG configuration, a set of PUSCHs or TBs with or without repetition are transmitted over the resources/transmission occasions. To distinguish the TOs within a CO configuration, one way is to introduce a new parameter which is used to indicate the number of the resources/transmission occasions within a CG configuration. Alternatively, the parameter, the number of repetitions, is reused to indicate the number of the resources/transmission occasions within a CG configuration. In some embodiments, the multiple TOs within a CG configuration is continuous or non-continuous. When multiple PUSCHs or TBs with repetition are enabled, a transmission pattern of the multiple PUSCHs or TBs on the transmission occasions within a CG configuration should be determined. The transmission pattern may be multiple TBs/PUSCHs with repetition first or multiple TBs/PUSCHs without repetition first. In some embodiments, multiple CG configurations with multiple transmission occasions may be configured.

For the multiple TOs within a CG configuration, the followings can be considered:

In a first possible implementation of the present application, all resources/transmission occasions (TOs) within a CG configuration share the same parameters except HARQ-ID and/or repetition occasion (RO) index, for example. The parameters of the CG configuration can be used to be applied to the multiple transmission occasions. Furthermore, a new parameter or a new column in TDRA table is introduced for determining the number of transmission occasions within a CG configuration. The pattern of TOs within a CG configuration can be back-to-back (i.e., the TOs are arranged side by side), or non-back-to-back (i.e., the TOs are not arranged side by side), or continuous, or non-continuous. The new parameter can be indicated by Radio Resource Control (RRC), or by Medium Access Control (MAC) Control Element (CE), or by Downlink control information (DCI). For instances, as shown in FIG. 5, the frame structure is DDSUU, the periodicity of a CG configuration is 10 slots, and the parameters of the CG configuration are configured in TO1. There are 4 TOs within a CG configuration configured by RRC or by activation DCI. The total 4 TOs (TO1, TO2, TO3, TO4) within a CG configuration are indicated, and the parameters of TO2, TO3, TO4 share that of TO1.

In some embodiments, an index can be introduced for indicating the TOs within a CG Configuration. The index can be indicated by RRC or MAC CE or DCI. In some embodiments, two-stage index can be considered to identify the TOs within a CG configuration, in which one stage of the two-stage index is a CG configuration index (e.g., CG index in 3GPP Release 16), and the other stage of the two-stage index is a TO index within a CG configuration, where the index is from 0 to the number of TOs minus 1 or from 1 to the number of TOs, as shown in FIG. 6.

In some embodiments, multiple TOs and repetitions can be configured within a CG configuration. A new parameter within ConfiguredGrantconfi/activation signaling (e.g., RRC or DCI) or a new signaling can be introduced to indicate the number of TOs without repetition. The transmission pattern can be multiple TBs/PUSCHs with repetition first or multiple TBs/PUSCHs without repetition first. In some embodiments, the transmission pattern that is directed to multiple TBs/PUSCHs with repetition first or multiple TBs/PUSCHs without repetition first can be configurable. The multiple TBs/PUSCHs with repetition first means the first TB and corresponding repetition(s) to the first TB can be transmitted before the second TB, the second TB and corresponding repetition(s) to the second TB can be transmitted before the third TB, and so on. For instance, as shown in FIG. 7, the frame structure is DSUUUDSUUU, there are 3 TOs (PUSCHs or TBs) with 2 repetitions configured within a CG configuration, and the total number of TOs is equal to 3*2=6, denoted as TO1, TO2, TO3, TO4, TO5, and TO6. The first TB is transmitted on TO1 and the repetition of the first TB is transmitted on TO2, the second TB is transmitted on TO3 and the repetition of the second TB is transmitted on TO4, and the third TB is transmitted on TO5 and the repetition of the third TB is transmitted on TO6.

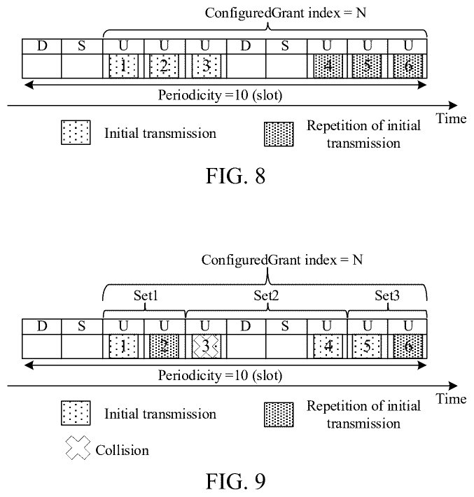

The multiple TBs/PUSCHs without repetition first means all of TBs within a CG configuration are transmitted first and then corresponding repetitions. For instance, as shown in FIG. 8, the frame structure is DSUUUDSUUU, there are 3 TOs (PUSCHs or TBs) with 2 repetitions configured within a CG configuration, and the total number of TOs is equal to 3*2=6, denoted as TO1, TO2, TO3, TO4, TO5, and TO6. The first TB is transmitted on TO1 and the repetition of the first TB is transmitted on TO4, the second TB is transmitted on TO2 and the repetition of the second TB is transmitted on TO5, and the third TB is transmitted on TO3 and the repetition of the third TB is transmitted on TO6.

In some embodiments, the Redundancy Version Identification (RV-id) is the same for all PUSCH transmissions except the repetition(s) on the TOs within a CG configuration, and the RV-id can be RV 0, for example.

In some embodiments, the reference HARQ-ID of TOs within a CG configuration is based on the transmission occasion configured first within a CG configuration, and the HARQ-ID of the remaining TOs within the CG configuration is based on the reference HARQ-ID plus a HARQ-offset value, or a fixed value, or the index of the TOs, or the index of the TOs minus 1 within the CG configuration. For instance, the reference HARQ-ID is the HARQ-ID of the TO configured first within the CG configuration, the HARQ-ID value of the last TO is equal to: (HARQ-ID−1) mod HARQ_process_number or ((HARQ-ID−1) mod HARQ_process_number)+1. For instance, as shown in FIG. 6, the total number of TOs within a CG configuration is 4, and the index of TOs is from 1 to 4. The reference HARQ-ID is calculated based on TO1 and the calculated value is N1. The total number of HARQ process is M, and then the HARQ-ID of TO1 is (N1+1−1) mod M or ((N1−1) mod M)+1; the HARQ-ID of TO2 is (N1+2−1) mod M or ((N1+2−1−1) mod M)+1; the HARQ-ID of T3 is (N1+3−1) mod M or ((N1+3−1−1) mod M)+1; and the HARQ-ID of TO4 is (N1+4−1) mod M or ((N1+4−1−1) mod M)+1.

In some embodiments, the HARQ-ID of each TO is based on it's corresponding time and/or frequency resources.

In some embodiments, the reference HARQ-ID of TOs within a CG configuration is based on the first actual transmission occasion within a CG configuration, in which the first actual transmission occasion means a TO with a PUSCH transmission, and the HARQ-ID of the remaining TOs within the CG configuration is based on the reference HARQ-ID plus a HARQ-offset value, or a fixed value, or the index of the TOs within the CG configuration, where the reference HARQ-ID is the HARQ-ID for the first actual TO within the CG configuration, and the HARQ-ID value of the last TO is equal to: (HARQ-ID−1) mod HARQ_process_number or ((HARQ-ID−1) mod HARQ_process_number)+1.

In some embodiments, the TOs can be grouped into several sets, the HARQ-ID of TOs within each set is the same, and the HARQ-ID of TOs within different sets is different. The HARQ-ID of each set may be based on the first configured TO or the first actual TO.

In a second possible implementation of the present application, the parameters of all resources/transmission occasions (TOs) within a CO configuration can be shared or not shared. The number of repetitions indicated by RRC or DCI can be used to indicate the number of TOs within a CG configuration. The pattern of TOs within a CG configuration can be back-to-back (i.e., the TOs are arranged side by side), or non-back-to-back (i.e., the TOs are not arranged side by side), or continuous, or non-continuous. In accordance with this way, a new parameter in RRC or a new signaling can be introduced to enable the parameter of the number of repetitions to be used to indicate the number of TOs within a CG configuration. In some embodiments, when multiple TOs and repetitions are configured within a CG configuration, a pre-defined value or a fixed value can be used to determine the number of repetitions.

In a third possible implementation of the present application, each resource/transmission occasion within a CG configuration is configured with an individual set of parameters. At least one of the following parameters is different for each one of the multiple transmission occasions within a CG configuration:
Frequency Domain Resource Assignment (FDRA);
Time Domain Resource Allocation (TDRA);
PUSCH mapping type;
Hybrid Automatic Repeat Request identification (HARQ-ID);
Redundancy Version (RV); or
Modulation and coding scheme (MCS).

In accordance with this way, the number of TOs within a CO configuration can be indicated by TDRA, or FDRA, or MCS, or HARQ-ID implicitly, and the number of values in a field of at least one of these parameters can be used to determine the number of TOs within the CO configuration.

In some embodiments, the number of transmission occasions is based on available transmission occasions. The available TO means a TO that can be used for PUSCH transmission (which means a configured resource on a TO that does not collide with other transmissions or with valid symbols).

In addition, when some resources are collided with other transmissions, how to map the PUSCHs/TBs by UE is studied. A PUSCH/TB can be mapped to a set of TOs when one or more TOs within a set are collided with other transmissions or frame structure. Then, a TB is allocated to one of the remaining TOs within the set, and the TB cannot be allocated across the set of TOs. For instance, as shown in FIG. 9, the frame structure is DSUUUDSUUU, there are 3 TOs (PUSCHs or TBs) with 2 repetitions configured within a CG configuration (which means there are 3 sets of TOs, in which set 1 includes TO1 and TO2, set 2 includes TO3 and TO4, and set 3 includes TO5 and TO6), and the total number of TOs is equal to 3*2=6, denoted as TO1, TO2, TO3, TO4, TO5, and TO6. Then, the first TB is transmitted on TO1 and the repetition of the first TB is transmitted on TO2, the second TB is transmitted on TO3 and the repetition of the second TB is transmitted on TO4, the third TB is transmitted on TO5 and the repetition of the third TB is transmitted on TO6. When TO3 is collided with other transmissions, the first TB is transmitted on TO1 and the repetition of the first TB is transmitted on TO2, the second TB is transmitted on TO4 and the transmission is initial transmission, and the third TB is transmitted on TO5 and the repetition of the third TB is transmitted on TO6. The HARQ-ID of the second TB is based on the time resources (e.g., the first symbol) of TO3 or TO4.

In some embodiments, when some resources are collided with other transmissions, a PUSCH/TB can be mapped to one or more sets of TOs. When one or more TOs within a set are collided with other transmissions or frame structure, a TB may be allocated to one of the remaining TOs within the set or one of next several TOs within adjacent TO set until the number of transmissions for the TB achieves a configured value. For instance, as shown in FIG. 9, the frame structure is DSUUUDSUUU, there are 3 TOs (PUSCHs or TBs) with 2 repetitions configured within a CG configuration (which means there are 3 sets of TOs, in which set 1 includes TO1 and TO2, set 2 includes TO3 and TO4, and set 3 includes TO5 and TO6), and the total number of TOs is equal to 3*2=6, denoted as TO1, TO2, TO3, TO4, TO5, and TO6. Then, the first TB is transmitted on TO1 and the repetition of the first TB is transmitted on TO2, the second TB is transmitted on TO3 and the repetition of the second TB is transmitted on TO4, the third TB is transmitted on TO5 and the repetition of the third TB is transmitted on TO6. When TO3 is collided with other transmissions, the first TB is transmitted on TO1 and the repetition of the first TB is transmitted on TO2, the second TB is transmitted on TO4 and the repetition of the second TB is transmitted on TO5, and the third TB is transmitted on TO6 and the transmission is initial transmission. The HARQ-ID of the second TB is based on the time resources (e.g., the first symbol) of TO3 or TO4. The HARQ-ID of the third TB is based on the time resources (e.g., the first symbol) of TO5 or TO6.

In addition, when the size of an actual arrived packet is smaller than an expected value due to varying frame size of XR/traffic, a portion of configured resources will be wasted. So how to indicate unused resources within a CG configuration may be considered. A MAC CE, or UCI or CG-UCI, or piggyback UCI can be used to indicate the unused resources or transmission occasions within a CO configuration. In some embodiments, the index of a TO can be indicated by the signaling, and the corresponding TO within the CG configuration is indicated as an unused TO. When an index or a set indexes of TO(s) is indicated, one or more corresponding TOs are indicated as un-used. In some embodiments, the index of a TO can be indicated by the signaling, and corresponding TOs from the index to the end of TOs within the CG configuration are indicated as unused TOs. In some embodiments, when the signaling used to indicate unused TOs exists, adjacent TOs within a CG configuration near the signaling are indicated as unused TOs. In some embodiments, when the signaling used to indicate unused TOs exists, adjacent TOs which are larger than a threshold value are indicated as unused TOs. In some embodiments, a bitmap carried by the signaling can be used to indicate unused TOs, in which the state of “0” can be used to indicate a corresponding TO as an unused TO, or the state of “1” can be used to indicate a corresponding TO as an unused TO. In some embodiments, when the signaling used to indicate unused TOs exists, unused TOs are indicated from an adjacent TO near the signaling to the end of TOs within the CG configuration.

In a fourth possible implementation of the present application, multiple sets of parameters of a TO within a CG configuration can be configured, and a signaling (e.g., DCI, UCI, MAC CE) can be used to indicate one set of parameters among the multiple sets. Each set of parameters within multiple sets of parameters determine a TO configuration, and the TO configurations can carry same or different TB sizes. In some embodiments, an index can be used to identify one of the multiple sets of parameters.

Further details on how to reduce the overhead of Buffer Status Report (BSR) update are described as follows.

For XR services for example, a large buffer will be generated, and this results in having to indicate with a high index in the BSR procedure based on the existing BSR table. The higher the BSR index, the larger the buffer inaccuracy. A new table of BSR may be designed for XR services. Furthermore, when a PDU set is discarded by UE, BSR update will be needed in order for gNB to obtain accurate BSR information. However, BSR update based on detailed BSR size will cause signaling overhead. As a result, some enhancement approaches should be considered. This application proposes approaches to update the BSR size of XR. A change rate of BSR for XR can be reported to gNB by UE. For instance, when a PDU set is discarded at UE side, UE needs to update the BSR value in order to report with an accurate value of XR BSR. A new type of MAC CE used to update the BSR value can be considered. The new type of MAC CE is not used to indicate the actual traffic size of BSR. Instead, a reduction rate is indicated based on previous report.

In some embodiments, the new MAC CE can be used to update BSR change rate, and the following parameters may be included:
LCH-ID
LCH-group ID
The rate of change
The PDB after updates

The rate of change can be pre-defined or configured in a table, in which each state (index) in the table can be used to indicate a rate value for the BSR update, and the state (index) is indicated by the MAC CE.

In some embodiments, a UCI or piggyback UCI can be used to update BSR with the change rate, and the following parameters may be included:
LCH-ID
LCH-group ID
The rate of change
The PDB after updates

Likewise, the rate of change can be pre-defined or configured in a table, in which each state (index) in the table can be used to indicate a rate value for the BSR update, and the state (index) is indicated by the UCI or piggyback UCI In some embodiments, the rate value for the BSR update can be a negative or positive value, in which negative values indicate the BSR size decreases and positive values indicate the BSR size increases.

Commercial interests for some embodiments are as follows. 1. Solving issues in the prior art. 2. Realizing multiple transmission occasions (TOs) within a CG configuration. 3. Achieving indication of unused resources/transmission occasions within a CG configuration, 4. Reducing signaling overhead of Buffer Status Report (BSR) update. 5. Providing a good communication performance. Some embodiments of the present application are used by SG-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present application are a combination of “techniques/processes” that can be adopted in 3GPP specification to create an end product. Some embodiments of the present application could be adopted in the 5G NR unlicensed band communications. Some embodiments of the present application propose technical mechanisms.

The embodiment of the present application further provides a computer readable storage medium for storing a computer program. The computer readable storage medium enables a computer to execute corresponding processes implemented by the UE/BS in each of the methods of the embodiments of the present application. For brevity, details will not be described herein again.

The embodiment of the present application further provides a computer program product including computer program instructions. The computer program product enables a computer to execute corresponding processes implemented by the UE/BS in each of the methods of the embodiments of the present application. For brevity, details will not be described herein again.

The embodiment of the present application further provides a computer program. The computer program enables a computer to execute corresponding processes implemented by the UE/BS in each of the methods of the embodiments of the present application. For brevity, details will not be described herein again.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using. for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different approaches to implement the described functions for each particular application, but it should not be considered that the implementation goes beyond the scope of the present application.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A wireless communication method, performed by a user equipment (UE), the method comprising:
being configured with multiple resources or transmission occasions (TOs) within a configured grant (CG) configuration.

2. The method of claim 1, wherein the number of resources or TOs within the CG configuration is indicated by a set of parameters.

3. The method of claim 2, wherein the set of parameters are indicated by Radio Resource Control (RRC), or by Medium Access Control (MAC) Control Element (CE), or by Downlink control information (DCI).

4-7. (canceled)

8. The method of claim 1, wherein each resource or TO within a CG configuration is configured with an individual set of parameters.

9. The method of claim 8, wherein at least one of the following parameters is different for each one of the multiple resources or TOs within the CG configuration:
Frequency Domain Resource Assignment (FDRA);
Time Domain Resource Allocation (TDRA);
PUSCH mapping type;
Hybrid Automatic Repeat Request identification (HARQ-ID);
Redundancy Version (RV); or
Modulation and coding scheme (MCS).

10. The method of claim 8, wherein the number of resources or TOs within the CG configuration is determined based on at least one of the following parameters: TDRA, FDRA, MCS or HARQ-ID.

11. The method of claim 1, wherein an index is used to indicate each of the multiple resources or TOs within the CG configuration.

12. The method of claim 1, wherein two-stage index is used to identify the multiple TOs within the CG configuration, in which one stage of the two-stage index is a CG configuration index, and the other stage of the two-stage index is a TO index.

13-14. (canceled)

15. The method of claim 1, wherein a reference HARQ-ID of the multiple TOs within the CG configuration is based on a first transmission occasion configured within the CG configuration or a first actual transmission occasion which is a TO with a PUSCH transmission, and wherein the reference HARQ-ID is used to determine HARQ-ID of all the TOs within the CG configuration.

16-19. (canceled)

20. The method of claim 1, further comprising:
transmitting a signaling used to indicate unused resources or transmission occasions within the CG configuration, wherein the signaling is carried by UCI, the un-used TOs are indicated by bitmap.

21-27. (canceled)

28. A wireless communication method, performed by a base station (BS), the method comprising:
configuring a user equipment (UE) with multiple resources or transmission occasions (TOs) within a configured grant (CG) configuration.

29. The method of claim 28, wherein the number of TOs within the CG configuration is indicated by a set of parameters.

30. The method of claim 29, wherein the set of parameters are indicated by Radio Resource Control (RRC), or by Medium Access Control (MAC) Control Element (CE), or by Downlink control information (DCI).

31-34. (canceled)

35. The method of claim 28, wherein each TO within a CG configuration is configured with an individual set of parameters.

36. The method of claim 35, wherein at least one of the following parameters is different for each one of the multiple TOs within the CG configuration:
Frequency Domain Resource Assignment (FDRA);
Time Domain Resource Allocation (TDRA);
PUSCH mapping type;
Hybrid Automatic Repeat Request identification (HARQ-ID);
Redundancy Version (RV); or
Modulation and coding scheme (MCS).

37. (canceled)

38. The method of claim 28, wherein an index is used to indicate each of the multiple TOs within the CG configuration.

39. The method of claim 28, wherein two-stage index is used to identify the multiple TOs within the CG configuration, in which one stage of the two-stage index is a CG configuration index, and the other stage of the two-stage index is a TO index.

40-41. (canceled)

42. The method of claim 28, wherein a reference HARQ-ID of the multiple TOs within the CG configuration is based on a first transmission occasion configured within the CG configuration or a first actual transmission occasion which is a TO with a PUSCH transmission, and wherein the reference HARQ-ID is used to determine HARQ-ID of all the TOs within the CG configuration.

43-46. (canceled)

47. The method of claim 28, further comprising:
receiving from the UE a signaling used to indicate unused resources or transmission occasions within the CG configuration, Wherein the signaling is carried by UCI, the un-used TOs are indicated by bitmap.

48-54. (canceled)

55. A user equipment (UE), comprising a processor, configured to call and run program instructions stored in a memory, to execute the method of any of claim 1.

56. (canceled)
